(19) United States
(12) Patent Application Publication
(10) Pub. No.: US 2003/0093947 A1
(43) Pub. Date: May 22, 2003

(54) Method and apparatus for displaying plants

(76) Inventor: Douglas Bennett Gilberg, Wildwood, MO (US)

Correspondence Address: THOMPSON COBURN, LLP, ONE FIRSTAR PLAZA, SUITE 3500, ST LOUIS, MO, 63101, US

(21) Appl. No.: 09/989,330

(22) Filed: Nov. 20, 2001

(51) Int. Cl. A01G 5/00; A47G 7/00

(52) U.S. Cl. 47/41.01

(57) ABSTRACT

A plant display comprises a transparent container and a plant receptacle. The transparent container has an inner surface that defines an interior volume, which is adapted to be at least partially occupied by a substantially transparent liquid. The plant receptacle is positioned at least partially within the interior volume of the transparent container. The receptacle is placed within the container in a manner so that at least a portion of the receptacle is below a surface of the liquid occupying the container. The receptacle has an outer surface with at least one recess, which is at least partially occupied by a substrate medium. The recess and substrate medium occupying the recess are adapted to hold a live plant growing therein. The recess is located in a portion of the outer surface of the receptacle that is at least partially below the surface of the liquid so that the plant is at least partially below the surface of the liquid.

### BACKGROUND OF THE INVENTION

The present invention relates to plant displays and floral arrangements and, more particularly, to such displays and arrangements having plants or flowers living at least partially under water.

FIG. 1 shows a typical prior art underwater plant display, with plants P growing in gravel or in another rock substrate medium S situated on the floor of a substantially transparent container C. The container C is filled with water W or another substantially transparent nutrient solution. The plants P get needed nutrients from the surrounding nutrient solution W, and the rock substrate medium S provides a foundation in which roots R can attach and upon which the plants P can grow. The transparent container C allows the contents of the container to be viewed from the outside, and also allows the plants growing therein to receive light. Such displays are aesthetically pleasing, but are difficult to maintain. For example, before changing the water or cleaning the walls of the container, it is necessary to remove the plants from their rock substrate and empty the rock substrate before changing the water and cleaning the container, which is time consuming and potentially traumatizing to the plants.

Thus, there is a need for a plant display that is similarly pleasing from an aesthetic standpoint, but which is easier to maintain than prior art arrangements.

### SUMMARY OF THE INVENTION

It is a general object of the present invention to provide a plant display that is aesthetically pleasing and also easy to maintain. Another object of the invention is to provide a method and apparatus for displaying underwater plants in a manner so that the plants can be easily removed from their container in a non-traumatizing manner while the container is being cleaned. Still another object is to provide a method and apparatus for displaying a plurality of plants comprising a removable plant receptacle that is configured so that some of the plants are growing substantially underwater and others are positioned adjacent the surface of the water. A more specific object of the invention is to provide a method and apparatus for displaying underwater plants, which utilize a plant receptacle holding plants growing in a substrate medium, wherein the receptacle is movable into and out of a liquid-filled container while holding the plants therein.

In general, a plant display of the present invention comprises a transparent container and a plant receptacle. The transparent container has an interior volume adapted to be at least partially occupied by a substantially transparent liquid. The plant receptacle is positioned at least partially within the interior volume of the transparent container. The receptacle is placed within the container in a manner so that at least a portion of the receptacle is below a surface of the liquid occupying the container. The receptacle has an outer surface with at least one recess, which is at least partially occupied by a substrate medium. The recess and substrate medium occupying the recess are adapted to hold a live plant growing therein. The recess is located in a portion of the outer surface of the receptacle that is at least partially below the surface of the liquid so that the plant is at least partially below the surface of the liquid.

In another aspect of the invention, a plant display comprises a transparent container and a plant receptacle having a first recess and a second recess. The transparent container has an interior volume that is at least partially occupied by a substantially transparent liquid. The plant receptacle is positioned at least partially within the interior volume of the container so that at least a portion of the receptacle is below a surface of the liquid. The first recess is at least partially occupied by a first substrate medium, and the second recess is at least partially occupied by a second substrate medium. The first recess and first substrate medium are adapted to hold a first live plant growing therein. The first recess is located in a portion of the outer surface of the receptacle that is below the surface of the liquid so that the first plant is at least partially below the surface of the liquid. The second recess and second substrate medium are adapted to hold a second live plant growing therein. The second recess is located in a portion of the outer surface of the receptacle that is above the surface of the liquid occupying the container so that the second plant is above the surface of the liquid.

A method of the invention for managing a plant display comprises the steps of: providing a transparent container; at least partially filling the container with a substantially transparent liquid; providing a plant receptacle having an outer surface with at least one recess; at least partially filling the recess with a substrate medium; planting a live plant in the substrate medium; and positioning the receptacle at least partially within the interior volume of the transparent container in a manner so that the recess is below a surface of the liquid occupying the container.

While the principal advantages and features of the present invention have been described above, a more complete and thorough understanding and appreciation for the invention may be attained by referring to the drawings and detailed description of the preferred embodiments, which follow.

### BRIEF DESCRIPTION OF THE DRAWINGS

FIG. 1 is a perspective view of a prior art underwater plant display;

FIG. 2 is a perspective view of a plant display of the present invention;

FIG. 3 is a cross-sectional side view of a plant receptacle used with the plant display of FIG. 2;

FIG. 4 is a perspective view of an alternative embodiment of a plant display of the present invention;

FIG. 5 shows an alternative embodiment of a plant receptacle used in the present invention, which resembles a vegetable organism; and

FIG. 6 shows another alternative embodiment of a plant receptacle used in the present invention, which resembles an animal.

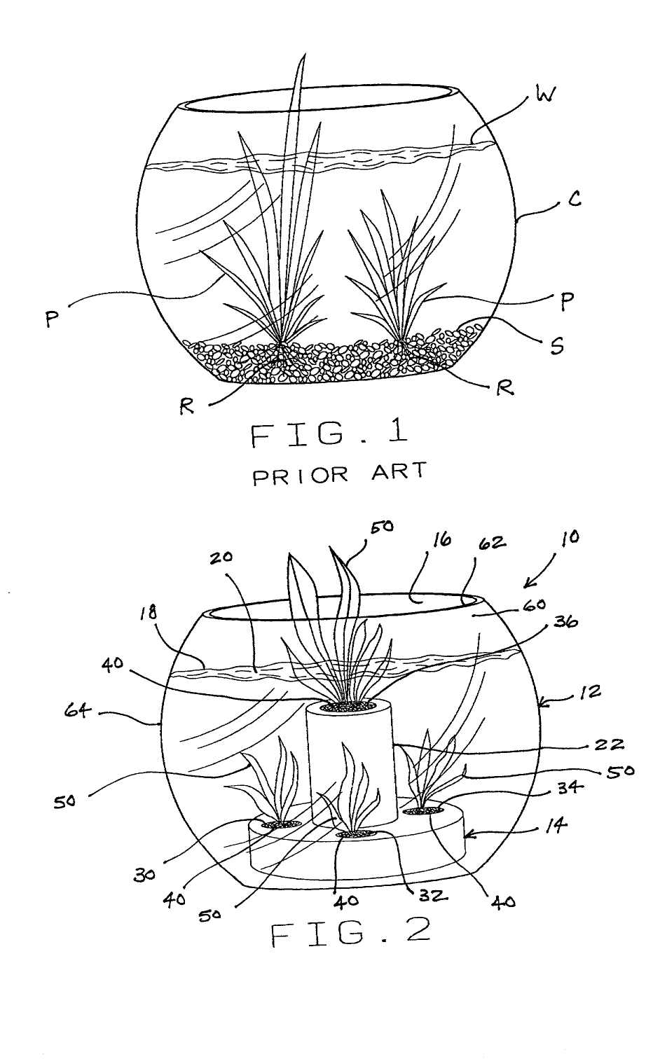

Reference characters in these figures correspond to reference characters used in the following detailed description of the preferred embodiments.

### DETAILED DESCRIPTION OF THE PREFERRED EMBODIMENTS

A plant display of the present invention is represented in its entirety in FIG. 2 by the reference numeral 10. In general, the plant display 10 comprises a transparent container 12 and a removable plant receptacle 14. The container 12 has an inner surface 16 defining an interior volume, which is adapted to be at least partially occupied by a substantially transparent liquid 18. The plant receptacle 14 is removably positioned at least partially within the interior volume of the container 12 in a manner so that at least a portion of the receptacle 14 is below a surface 20 of the liquid 18 occupying the container 12. The receptacle has an outer surface 22 with a plurality of recesses 30, 32, 34 and 36, each of which is at least partially occupied by a substrate medium 40. The recesses 30, 32, 34 and 36 and substrate medium 40 are adapted to hold live plants 50 growing therein. As explained below in greater detail, at least some of the recesses are preferably at least partially below the surface 20 of the liquid 18 occupying the container 12 when the plant receptacle 14 is positioned within the interior volume of the container 12.

In the preferred embodiment of the invention shown in FIG. 2, the container 12 is preferably a transparent glass bowl, though the container 12 could be of other transparent materials, such as transparent plastic, without departing from the scope of the invention. Alternatively, the container 12 could be of semi-transparent or translucent materials. For example, the container could be of a tinted transparent material that adds color, but still permits viewing of the contents of the container. Also, alternatively, the container 12 could be configured with only portions or “windows” that are transparent, semi-transparent or translucent to permit viewing of the contents of the container 12, with other portions of the container 12 being opaque.

As shown in FIG. 2, an upper portion 60 of the transparent container 12 includes an opening 62 that is large enough to permit the plant receptacle 14 to be removed from the container 12 through the opening 62. Preferably, the opening 62 is shaped and sized to permit the plant receptacle 14 to be removed from the container 12 through the opening 62 while plants 50 are held in the substrate medium 40 occupying the recesses 30, 32, 34 and 36.

With continued reference to FIG. 2, in the preferred embodiment of the invention, at least a portion of the transparent container 12 has a convex configuration so that, when viewed from outside the container 12 through the convex portion, contents of the container 12 appear magnified. More preferably, and as depicted in FIG. 2, the container is a generally spherical bowl having a generally spherical outer surface 64 that serves to magnify the contents of the container 12 when viewed from outside the container 12 through the generally spherical outer surface 64. Alternatively, the container could be made in other configurations, including configurations having flat or concave surface portions that create different special effects when viewing the contents of the container 12 through such portions.

Again, the interior volume of the container 12 is adapted to be at least partially occupied by a substantially transparent liquid 18. Preferably, the liquid 18 is water or another water-based solution containing nutrients beneficial to the plants 50. Preferably, the liquid 18 is substantially transparent so as to permit viewing of the plant receptacle 14 and plants 50 from outside the container 12. Alternatively, the liquid could be tinted or otherwise colored with a dye to create a special effect.

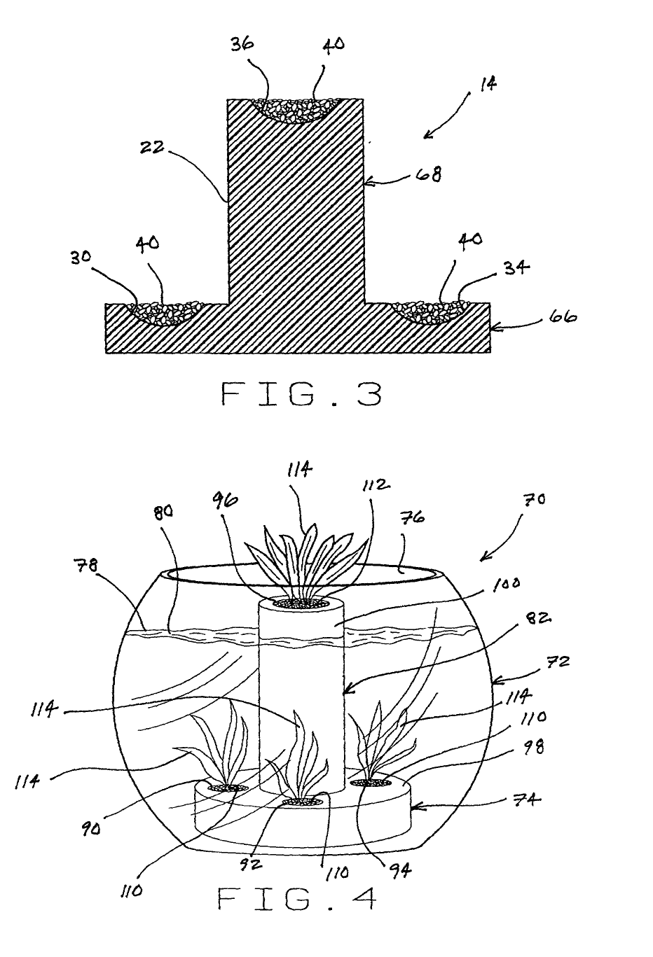

A preferred embodiment of the plant receptacle 14 is shown in FIGS. 2 and 3. FIG. 2 is a perspective view of the plant display 10 of the invention in use. FIG. 3 is a somewhat schematic cross-sectional side view of the plant receptacle 14 shown in FIG. 2. Again, the outer surface 22 of the plant receptacle 14 includes a plurality of recesses 30, 32, 34 and 36. In the embodiment of the plant receptacle 14 shown in FIGS. 2 and 3, recesses 30, 32 and 34 are at a lower level 66 of the outer surface 22 of the plant receptacle 14, and recess 36 is at an upper level 68 of the outer surface 22 of the plant receptacle 14. Thus, as shown in FIG. 2, when the plant display 10 is in use, the plant receptacle 14 is positioned with the interior volume of the container 12, and the interior volume of the container is at least partially occupied by the liquid 18, the lower level recesses 30, 32 and 34 are well below the surface 20 of the liquid and the upper level recess 36 is generally adjacent the surface 20, but still below the surface 20.

FIG. 4 shows an alternative embodiment of a plant display 70 of the present invention comprising a transparent container 72 and a removable plant receptacle 74. The container 72 has an inner surface 76 defining an interior volume, which is adapted to be at least partially occupied by a substantially transparent liquid 78. The plant receptacle 74 is removably positioned at least partially within the interior volume of the container 72 in a manner so that at least a portion of the receptacle 74 is below a surface 80 of the liquid 78 occupying the container 72. The receptacle has an outer surface 82 with a plurality of recesses 90, 92, 94 and 96. As explained below in more detail, each of the recesses 90, 92, 94 and 96 is at least partially occupied by a substrate medium. In the plant receptacle 74 shown in FIG. 4, recesses 90, 92 and 94 are at a lower level 98 of the outer surface 82 of the plant receptacle 74, and recess 96 is at an upper level 100 of the outer surface 82 of the plant receptacle 74. Thus, as shown in FIG. 4, when the plant display 70 is in use, the plant receptacle 74 is positioned with the interior volume of the container 72, and the interior volume of the container is at least partially occupied by the liquid 78, the lower level recesses 90, 92 and 94 are well below a surface 79 of the liquid 78 and the upper level recess 96 is generally adjacent the surface 79, but the upper level 100 of the outer surface 82 of the receptacle extends upwardly from the lower level 98 a distance sufficient so that the recess 96 and its contents are above the surface 79 of the liquid 78.

Preferably, the plant receptacles 14 and 74 are each of a synthetic material, such as a molded thermoplastic material or other polymeric material. Such materials are preferred because they are lightweight, relatively inexpensive, relatively easy to mold or otherwise form into virtually any desired shape, available in a variety of colors, and generally resistant to corrosion. Preferably, as shown in FIGS. 2 and 3, the plant receptacle 14 is formed as a monolithic piece, to facilitate movement of the receptacle 14, along with its contents, into and out of the interior volume of the container 12 as a unit. Similarly, as shown in FIG. 4, the plant receptacle 74 is preferably formed as a monolithic piece, to facilitate movement of the receptacle 74, along with its contents, into and out of the interior volume of the container 72 as a unit. Alternatively, the receptacles 14 and 74 could be partially or completely made of other materials, such as ceramic, metal or wood, without departing from the scope of the present invention.

Referring again to FIGS. 2 and 3, at least some of the recesses 30, 32, 34 and 36 are at least partially occupied by a substrate medium 40, which is adapted to hold live plants 50 growing therein. The substrate medium 40 serves as a foundation in which roots (not shown) of the plants 50 can attach and upon which the plants 50 can grow. Preferably, the substrate medium 40 is of a synthetic material having sufficient structure to provide a suitable foundation, but being generally resistant to corrosion and decay. Also, preferably, the substrate medium 40 is heavier than the liquid 18 so that it does not float to the surface of the liquid 18 when the receptacle 14 is positioned within the container 12. In the preferred embodiment of the invention, the substrate medium 40 comprises fiberglass batting, though other materials such as polystyrene, or polymeric pellets, marbles or beads could be used without departing from the scope of the invention. Although synthetic substrate mediums are preferred because they are easy to maintain, an organic substrate medium, such as soil, sand or rocks, could be used without departing from the scope of the invention.

With continued reference to FIG. 2, the recesses 30, 32, 34 and 36 and substrate medium 40 contained therein are adapted to hold live plants 50, with the substrate medium 40 serving as a foundation in which the plants 50 contained in the recesses can grow. As explained above, in the embodiment shown in FIGS. 2 and 3, recesses 30, 32 and 34 are at the lower level 66 of the outer surface 22 of the receptacle 14, and recess 36 is at the upper level 68 of the outer surface 22 of the receptacle 14. Thus, when the plant display 10 is in use, the receptacle 14 is positioned with the interior volume of the container 12, and the interior volume of the container is at least partially occupied by the liquid 18, the plants 50 occupying the lower level recesses 30, 32 and 34 are substantially or entirely below the surface 20 of the liquid 18, and the plant 50 occupying the upper level recess 36 is generally adjacent the surface 20, but at least partially below the surface 20.

Referring now to the embodiment of FIG. 4, at least some of the lower level recesses 90, 92 and 94 preferably contain a first substrate medium 110 and the upper level recess 96 preferably contains a second substrate medium 112. Each of the recesses 90, 92, 94 and 96 is adapted to hold a live plant 114, with the substrate medium 110 or 112 serving as a foundation in which the plants 114 contained in the recesses can grow. As explained above, in the embodiment shown in FIG. 4, recesses 90, 92 and 94 are at the lower level 98 of the outer surface 82 of the receptacle 74, and recess 96 is at the upper level 100 of the outer surface 82 of the receptacle 74. Thus, as shown in FIG. 4, when the plant display 70 is in use, the receptacle 74 is positioned with the interior volume of the container 72, and the interior volume of the container is at least partially occupied by the liquid 78, the plants 114 occupying the lower level recesses 90, 92 and 94 are substantially or entirely below the surface 79 of the liquid 78, and the plant 114 occupying the upper level recess 96 is generally adjacent the surface 79, but the upper level 100 of the outer surface 82 of the receptacle extends upwardly from the lower level 98 a distance sufficient so that the plant 114 held in upper level recess 96 entirely above the surface 79 of the liquid 78.

Preferably, the first substrate medium 110, which occupies at least some of the lower level recesses 90, 92 and 94, is of a synthetic material similar to substrate medium 40 described above, e.g., fiberglass batting, having sufficient structure to provide a suitable foundation, but being generally resistant to corrosion and decay. The second substrate medium 112, which occupies the upper level recess 96, may be of a synthetic material similar to substrate medium 40 described above or may be of an organic material, such as soil. Synthetic substrate mediums are preferred for the lower level recesses because they are easy to maintain and are less likely to cloud or otherwise contaminate the liquid held in the container. However, again, in the embodiment shown in FIG. 4, the upper level 100 of the receptacle 74 extends upwardly a distance sufficient so that the recess 96, the second substrate 112, and the plant 114 held therein, are entirely above the surface 79 of the liquid 78. In this way, the second substrate 112 and the plant 114 held therein are isolated from contents of the lower level recesses 90, 92 and 94 and also isolated from the liquid occupying the container. Thus, if the second substrate 112 comprises soil or another liquid soluble medium, it will not cloud or otherwise contaminate the liquid held in the container. Accordingly, the upper level recess 96 can be used for growing plants that are accustomed to growing in the air in an ordinary soil environment.

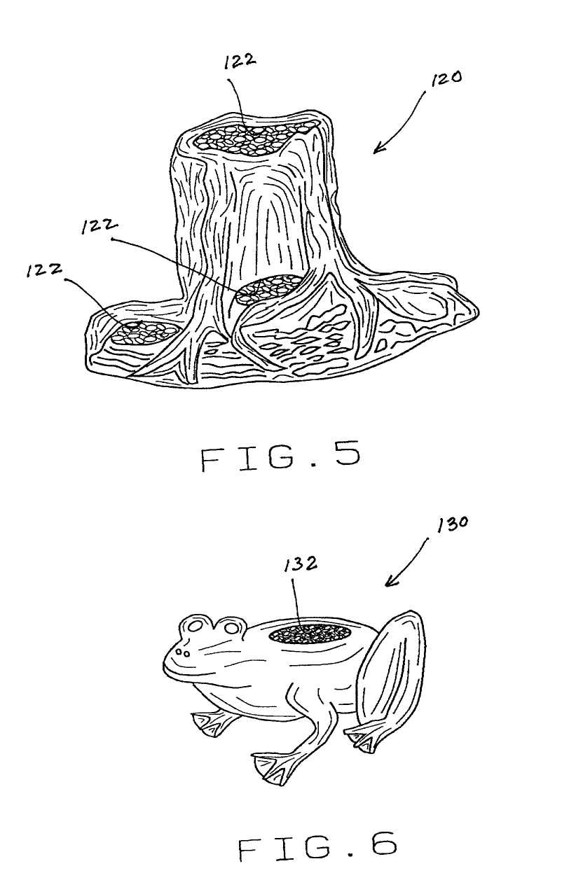

For purposes of discussion, the plant receptacles 14 and 74 shown in FIGS. 2 and 4, respectively, are somewhat schematic in nature and, consequently, are not particularly ornamental. It should be understood that these receptacles could be formed in an almost infinite number of shapes and configurations for decorative purposes. For example, FIG. 5 shows an alternative embodiment of a plant receptacle 120 used in the present invention, which resembles a vegetable organism, i.e., a tree trunk. The receptacle 120 includes a plurality of recesses 122 filled at least partially with a substrate medium. FIG. 6 shows another example of an alternative embodiment of a plant receptacle 130 used in the present invention, which resembles an animal, i.e., a frog. The receptacle 130 includes one recess 132 filled at least partially with a substrate medium. When made from preferred materials, such as molded thermoplastics, the receptacles can be easily molded into virtually any desired shape, e.g., animals, miniature houses, cartoon characters, trees, etc., without departing from the scope of the invention as claimed.

Utilizing apparatus like those described above, a novel method of managing a plant display 10 comprises the steps of: providing a transparent container 12 having an inner surface 16 defining an interior volume of the container 12; at least partially filling the interior volume of the container 12 with a substantially transparent liquid 18; providing a plant receptacle 14 having an outer surface 22 with a plurality of recesses 30, 32, 34 and 36; at least partially filling the recesses with a substrate medium 40; planting live plants 50 in the substrate medium 40 occupying the recesses; and positioning the receptacle 14 at least partially within the interior volume of the transparent container 12 in a manner so that the recesses 30, 32, 34 and 36 are below a surface 20 of the liquid 18 occupying the container 12. Similar steps are performed for managing a plant display 70, except that the step of positioning the receptacle 74 at least partially within the interior volume of the transparent container 72 comprises positioning the receptacle 74 in a manner so that the recesses 90, 92 and 94 are below the surface 79 of the liquid 78 and so that the recess 96 is above the surface 79 of the liquid 78.

In both cases, the step of positioning the receptacle within the interior volume of the container is preferably performed after the steps of filling the recesses with the substrate medium and planting the plants in the substrate medium, so as to minimize the possibility of damaging the plants. Thus, to set up a plant display utilizing the receptacle 14 or receptacle 74, plants are planted in the recesses, which contain an amount of the substrate medium sufficient to serve as a foundation for the plants, the container is filled with liquid, and the receptacle (already carrying the plants and their substrate medium) is inserted at least partially into the container, as shown in FIGS. 2 and 4. Also, in both cases, the methods further comprise the step of preparing the transparent container for cleaning by removing the plant receptacle 14 or 74 from the interior volume of the transparent container while the substrate medium and live plants still occupy the recesses. Whether inserting or removing the receptacles 14 and 74, it is convenient to grasp the upper level 68 of the receptacle 14 (or the upper level 100 of the receptacle 74), which is generally adjacent the surface of the liquid.

While the present invention has been described by reference to specific embodiments and specific uses, it should be understood that other configurations and arrangements could be constructed, and different uses could be made, without departing from the scope of the invention as set forth in the following claims.

What is claimed is

1. A plant display comprising:
a transparent container having an inner surface defining an interior volume adapted to be at least partially occupied by a substantially transparent liquid;
a plant receptacle positioned at least partially within the interior volume of the transparent container in a manner so that at least a portion of the receptacle is below a surface of the liquid occupying the container when the container is at least partially occupied by the liquid, the receptacle having an outer surface with at least one recess, the recess being at least partially occupied by a substrate medium;
the recess and substrate medium occupying the recess being adapted to hold a live plant growing therein, wherein the recess is located in a portion of the outer surface of the receptacle that is at least partially below the surface of the liquid occupying the container when the container is at least partially occupied by the liquid so that the plant is at least partially below the surface of the liquid when the plant is held in the recess and substrate medium occupying the recess.

2. The plant display of claim 1 wherein an upper portion of the transparent container includes an opening that is sized to permit the plant receptacle to be removed from the container through the opening.

3. The plant display of claim 2 wherein the opening is sized to permit the plant receptacle to be removed from the container through the opening with the plant held in the substrate medium occupying the recess.

4. The plant display of claim 1 wherein at least a portion of the transparent container has a convex configuration so that, when viewed from outside the container through the convex portion, contents of the container appear magnified.

5. The plant display of claim 4 wherein the transparent container is a generally spherical bowl.

6. The plant display of claim 1 wherein the outer surface of the receptacle has a plurality of recesses, at least some of the recesses being located in a portion of the outer surface of the receptacle that is at least partially below the surface of the liquid occupying the container when the container is at least partially occupied by the liquid.

7. The plant display of claim 6 wherein at least some of the recesses are at least partially occupied by the substrate medium.

8. The plant display of claim 7 wherein each of said recesses occupied by the substrate medium is adapted to hold at least one live plant growing therein.

9. The plant display of claim 1 wherein the receptacle is of a synthetic material.

10. The plant display of claim 9 wherein the receptacle is of a molded polymeric material.

11. The plant display of claim 10 wherein the receptacle is of a monolithic piece of polymeric material.

12. The plant display of claim 1 wherein at least a portion of the receptacle is shaped to resemble an animal.

13. The plant display of claim 1 wherein at least a portion of the receptacle is shaped to resemble a vegetable organism.

14. The plant display of claim 1 wherein the substrate medium is of a synthetic material.

15. The plant display of claim 14 wherein the substrate medium comprises fiberglass batting.

16. The plant display of claim 1 wherein the recess is located in a portion of the outer surface of the receptacle that is sufficiently below the surface of the liquid so that substantially all of the plant is below the surface of the liquid, when the container is at least partially occupied by the liquid and when the plant is held in the recess.

17. The plant display of claim 1 wherein the recess is located in a portion of the outer surface of the receptacle that is sufficiently near the surface of the liquid so that a majority of the plant is growing above the surface of the liquid, when the container is at least partially occupied by the liquid and when the plant is held in the recess.

18. A plant display comprising:
a transparent container having an inner surface defining an interior volume that is at least partially occupied by a substantially transparent liquid;
a plant receptacle positioned at least partially within the interior volume of the transparent container so that at least a portion of the receptacle is below a surface of the liquid, the receptacle having an outer surface with a first recess that is at least partially occupied by a first substrate medium and a second recess that is at least partially occupied by a second substrate medium;
the first recess and first substrate medium being adapted to hold a first live plant growing therein, wherein the first recess is located in a portion of the outer surface of the receptacle that is below the surface of the liquid occupying the container when the container is at least partially occupied by the liquid so that the first plant is at least partially below the surface of the liquid; and
the second recess and second substrate medium being adapted to hold a second live plant growing therein, wherein the second recess is located in a portion of the outer surface of the receptacle that is above the surface of the liquid occupying the container when the container is at least partially occupied by the liquid so that the second plant is above the surface of the liquid.

19. The plant display of claim 18 wherein the first substrate medium is of a synthetic material.

20. The plant display of claim 19 wherein the first substrate medium comprises fiberglass batting.

21. The plant display of claim 18 wherein the second substrate medium is of an organic material.

22. The plant display of claim 18 wherein the receptacle is configured so that contents of the second recess are isolated from contents of the first recess.

23. The plant display of claim 18 wherein the receptacle is configured so that contents of the second recess are isolated from the liquid occupying the container.

24. The plant display of claim 18 wherein an upper portion of the transparent container includes an opening that is sized to permit the plant receptacle to be removed from the container through the opening.

25. The plant display of claim 18 wherein at least a portion of the transparent container has a convex configuration so that, when viewed from outside the container through the convex portion, contents of the container appear magnified.

26. The plant display of claim 18 wherein the receptacle is of a synthetic material.

27. The plant display of claim 18 wherein the receptacle is of a monolithic piece of polymeric material.

28. The plant display of claim 18 wherein at least a portion of the receptacle is shaped to resemble an animal.

29. The plant display of claim 18 wherein at least a portion of the receptacle is shaped to resemble a vegetable organism.

30. A method of managing a plant display comprising the steps of:
providing a transparent container having an inner surface defining an interior volume;
at least partially filling the interior volume of the container with a substantially transparent liquid;
providing a plant receptacle having an outer surface with at least one recess;
at least partially filling the recess with a substrate medium;
planting a live plant in the substrate medium occupying the recess; and
positioning the receptacle at least partially within the interior volume of the transparent container in a manner so that the recess is below a surface of the liquid occupying the container.

31. The method of claim 30 wherein the step of positioning the receptacle at least partially within the interior volume of the transparent container is performed after the steps of at least partially filling the recess with a substrate medium and planting a live plant in the substrate medium occupying the recess.

32. The method of claim 30 further comprising the step of preparing the transparent container for cleaning by removing the plant receptacle from the interior volume of the transparent container while the substrate medium and live plant still occupy the recess.
